(19) United States
(12) Patent Application Publication
(10) Pub. No.: US 2016/0145835 A1
(43) Pub. Date: May 26, 2016

(54) DEVICE FOR CONTROLLING CONTROL VALVE OF CONSTRUCTION MACHINE, METHOD FOR CONTROLLING SAME, AND METHOD FOR CONTROLLING DISCHARGE FLOW RATE OF HYDRAULIC PUMP

(71) Applicants: Jin-Wook KIM, Gyeongsangnam-do (KR); Sang-Hee LEE, Gyeongsangnam-do (KR); Hung-Ju SHIN, Gyeongsangnam-do (KR); VOLVO CONSTRUCTION EQUIPMENT AB, Eskilstuna (SE)

(72) Inventors: Jin-Wook KIM, Changwon-si (KR); Sang-Hee LEE, Changwon-si (KR); Hung-Ju SHIN, Gimhae-si (KR)

(73) Assignee: VOLVO CONSTRUCTION EQUIPMENT AB, Eskilstuna (SE)

(21) Appl. No.: 14/899,875

(22) PCT Filed: Jun. 26, 2013
(86) PCT No.: PCT/KR2013/005656

§ 371 Date: Dec. 18, 2015

(51) Int. Cl. E02F 9/22; F15B 13/04; F15B 11/08; E02F 9/26; E02F 9/20

(52) U.S. Cl. CPC E02F 9/2228; E02F 9/26; E02F 9/2235; E02F 9/2004; E02F 9/2285; E02F 9/2271; E02F 9/2296; F15B 11/08; F15B 13/0401; F15B 2211/20546; F15B 2211/255; F15B 2211/405; F15B 2211/41572; F15B 2211/426; F15B 2211/66

(57) ABSTRACT

An apparatus and method for controlling a control valve, and a method for controlling a discharge flow rate of a hydraulic pump for a construction machine are disclosed, which can control a spool shifting speed of a directional valve and a discharge flow rate of a hydraulic pump in accordance with a hydraulic fluid temperature in winter season with below zero temperatures. The apparatus for controlling a control valve includes a variable displacement hydraulic pump; a hydraulic actuator driven by hydraulic fluid that is supplied from the hydraulic pump; a control valve installed in a flow path between the hydraulic pump and the hydraulic actuator and shifted to control a start, stop, and direction change of the hydraulic actuator; an operation lever outputting an operation signal corresponding to an operation amount; a temperature sensor detecting a hydraulic fluid temperature of a hydraulic fluid tank connected to the hydraulic pump; and a controller applying a control signal that corresponds to the operation amount of the operation lever 3 to the control valve if the hydraulic fluid temperature detected through a signal from the temperature sensor is higher than a predetermined temperature, and adjusting the operation signal according to the operation amount of the operation lever in a predetermined increment rate to correspond to the detected hydraulic fluid temperature and applying the adjusted control signal to the control valve if the hydraulic fluid temperature detected through the signal from the temperature sensor is lower than the predetermined temperature.

### TECHNICAL FIELD

The present invention relates to an apparatus and method for controlling a control valve, and a method for controlling a discharge flow rate of a hydraulic pump for a construction machine, and more particularly, to an apparatus and method for controlling a control valve, and a method for controlling a discharge flow rate of a hydraulic pump for a construction machine, which can control a spool shifting speed of a directional valve and a discharge flow rate of a hydraulic pump in accordance with a hydraulic fluid temperature in winter season with below zero temperatures.

### BACKGROUND OF THE INVENTION

In general, hydraulic fluid for operating hydraulic actuators of a construction machine can be used in a temperature range of 90 degrees Celsius above zero (+90° C.) to 20 degrees Celsius below zero (−20° C.). Respective regions have different ambient temperatures, and a construction machine may be used in a work environment with below zero temperatures in winter season and in a work environment with about 50 degrees Celsius above zero (+50° C.) in summer season.

In particular, a directional valve does not operate at a pilot signal pressure that an operator desires due to viscosity of the hydraulic fluid and gap contraction of respective components in winter season with below zero temperatures. As an example, in the case of slowly operating the hydraulic actuator during a warm-up operation in a state where the directional valve is exposed to the below zero temperatures, a spool of the directional valve is thermally expanded by the high-temperature hydraulic fluid that is supplied thereto, and thus stick phenomenon occurs in the directional valve.

In this case, if a boom-down, arm-in, or swing operation is stopped, due to the spool stick, the spool does not return to a neutral position, but the boom-down or arm-in operation continues or a swing device continues its swing operation without being stopped.

In particular, during the worm-up operation in the winter season with below zero temperatures, a working device is not abruptly operated, but is finely manipulated by degrees. A notch is formed in the spool of the directional valve as a path for supplying the hydraulic fluid of a hydraulic pump to the hydraulic actuator. In this case, if the directional valve is slowly shifted, a notch section is not completely opened to form a micro-path. Accordingly, heat is generated as the high-temperature hydraulic fluid passes through the notch section, and due to this heat generation, the diameter of the notch section of the spool is abruptly expanded.

Due to this, the cause of occurrence of the stick phenomenon of the spool may become great, and thus probability that a safety accident occurs becomes high. Accordingly, on a below zero temperature condition in winter season, it is required to eliminate the stick phenomenon by decreasing the heat generation cause through complete opening of the notch section that is achieved by quick shifting of the notch section of the spool.

On the other hand, in the case of shifting the spool of the directional valve by pilot signal pressure that is applied when an operation lever (RCV) is operated, the pilot signal pressure is detected by a pressure sensor that is installed in a flow path between the operation lever and the directional valve, and an electrical signal is applied to an electro proportional pressure reducing valve (PPRV) of the hydraulic pump to control the discharge flow rate of the hydraulic pump that corresponds to the pilot signal pressure corresponding to a predetermined operation amount of the operation lever.

In this case, on the below zero temperature condition, the hydraulic fluid has high viscosity due to the lowered temperature of the hydraulic fluid, and thus the pilot signal pressure according to the operation amount of the operation lever is delayed due to a pressure loss while the pilot signal pressure is transferred to the spool of the directional valve. That is, a difference between the pilot signal pressure that is detected by the pressure sensor and the pilot signal pressure that is measured at an inlet of the spool becomes larger in comparison to the above zero temperature condition, and much more time is consumed in reaching a normal state of the pilot signal pressure.

Accordingly, the increase of a spool opening area is delayed, but a required flow rate of the hydraulic pump is determined by the electrical signal that is applied to the electro proportional pressure reducing valve corresponding to the pilot signal pressure detected by the pressure sensor regardless of the temperature of the hydraulic fluid. Due to this, the pressure loss is increased in comparison to the above zero temperature condition, and thus the pressure of the hydraulic fluid that is discharged from the hydraulic pump may be abruptly increased, or an abnormal phenomenon, such as trembling of the working device, may occur.

### SUMMARY OF THE INVENTION

Accordingly, the present invention has been made to solve the above-mentioned problems occurring in the related art, and one subject to be achieved by the present invention is to provide an apparatus and method for controlling a control valve for a construction machine, which can eliminate a spool stick phenomenon through quick shifting of a spool of a directional valve in the case where the temperature of hydraulic fluid becomes equal to or lower than a predetermined temperature in winter season with below zero temperatures.

Another subject to be achieved by the present invention is to provide a method for controlling a discharge flow rate of a hydraulic pump for a construction machine, which can delay the discharge flow rate of the hydraulic pump as much as a pilot signal pressure delay in the case where the temperature of hydraulic fluid becomes equal to or lower than a predetermined temperature.

### Technical Solution

In accordance with an aspect of the present invention, there is provided an apparatus for controlling a control valve for a construction machine, which includes a variable displacement hydraulic pump; a hydraulic actuator driven by hydraulic fluid that is supplied from the hydraulic pump; a control valve installed in a flow path between the hydraulic pump and the hydraulic actuator and shifted to control a start, stop, and direction change of the hydraulic actuator; an operation lever outputting an operation signal corresponding to an operation amount; a temperature sensor detecting a hydraulic fluid temperature of a hydraulic fluid tank connected to the hydraulic pump; and a controller applying a control signal that corresponds to the operation amount of the operation lever to the control valve if the hydraulic fluid temperature detected through a signal from the temperature sensor is higher than a predetermined temperature, and adjusting the operation signal according to the operation amount of the operation lever in a predetermined increment rate to correspond to the detected hydraulic fluid temperature and applying the adjusted control signal to the control valve if the hydraulic fluid temperature detected through the signal from the temperature sensor is lower than the predetermined temperature.

In accordance with another aspect of the present invention, there is provided a method for controlling a control valve for a construction machine including a variable displacement hydraulic pump, a hydraulic actuator driven by hydraulic fluid that is supplied from the hydraulic pump, a control valve installed in a flow path between the hydraulic pump and the hydraulic actuator and shifted to control a start, stop, and direction change of the hydraulic actuator, an operation lever outputting and operation signal corresponding to an operation amount, and a temperature sensor detecting a hydraulic fluid temperature of a hydraulic fluid tank connected to the hydraulic pump, which includes detecting the operation signal that corresponding to the operation amount of the operation lever; comparing the hydraulic fluid temperature detected through a signal of the temperature sensor with a predetermined temperature; applying a control signal that corresponds to the operation amount of the operation lever to the control valve if the hydraulic fluid temperature detected through the signal from the temperature sensor is higher than a predetermined temperature; and adjusting the operation signal according to the operation amount of the operation lever in a predetermined increment rate to correspond to the detected hydraulic fluid temperature and applying the adjusted control signal to the control valve if the hydraulic fluid temperature detected through the signal from the temperature sensor is lower than the predetermined temperature.

In accordance with still another aspect of the present invention, there is provided a method for controlling a discharge flow rate of a hydraulic pump for a construction machine including a variable displacement hydraulic pump, a hydraulic actuator driven by hydraulic fluid that is supplied from the hydraulic pump, a hydraulic operation lever outputting an operation signal to correspond to an operation amount, a control valve installed in a flow path between the hydraulic pump and the hydraulic actuator and shifted to control a start, stop, and direction change of the hydraulic actuator, a temperature sensor detecting a hydraulic fluid temperature of a hydraulic fluid tank, and an electro proportional pressure reducing valve controlling a discharge flow rate of the hydraulic pump through a secondary pressure that is generated to correspond to an applied electrical signal, which includes detecting a pilot signal pressure that is applied to the control valve to correspond to the operation amount of the operation lever; comparing the hydraulic fluid temperature detected by the temperature sensor with a predetermined hydraulic fluid upper limit temperature; applying an electrical signal that corresponds to the pilot signal pressure that is applied to the control valve to the electro proportional pressure reducing valve if the hydraulic fluid temperature detected through the signal from the temperature sensor is higher than the predetermined hydraulic fluid upper limit temperature; and calculating a gain value for decreasing the discharge flow rate of the hydraulic pump so that the gain value becomes larger as the detected hydraulic fluid temperature that belongs between certain hydraulic fluid upper limit temperature and lower limit temperature approaches the lower limit temperature and applying the electrical signal to the electro proportional pressure reducing valve to correspond to the calculated gain value if the hydraulic fluid temperature detected through the signal from the temperature sensor is lower than the predetermined hydraulic fluid upper limit temperature.

In accordance with yet still another aspect of the present invention, there is provided a method for controlling a discharge flow rate of a hydraulic pump for a construction machine including a variable displacement hydraulic pump, a hydraulic actuator driven by hydraulic fluid that is supplied from the hydraulic pump, an electronic operation lever outputting an electrical signal to correspond to an operation amount, a control valve installed in a flow path between the hydraulic pump and the hydraulic actuator and shifted to control a start, stop, and direction change of the hydraulic actuator, a temperature sensor detecting a hydraulic fluid temperature of a hydraulic fluid tank, and an electro proportional pressure reducing valve controlling a discharge flow rate of the hydraulic pump through a secondary pressure that is generated to correspond to an applied electrical signal, which includes detecting the electrical signal that is output in proportion to the operation amount of the operation lever; comparing the hydraulic fluid temperature detected by the temperature sensor with a predetermined hydraulic fluid upper limit temperature; applying an electrical signal that is proportional to the operation amount of the operation lever to the electro proportional pressure reducing valve if the hydraulic fluid temperature detected through the signal from the temperature sensor is higher than the predetermined hydraulic fluid upper limit temperature; and calculating a gain value for decreasing the discharge flow rate of the hydraulic pump so that the gain value becomes larger as the detected hydraulic fluid temperature that belongs between certain hydraulic fluid upper limit temperature and lower limit temperature approaches the lower limit temperature and applying the electrical signal to the electro proportional pressure reducing valve to correspond to the calculated gain value if the hydraulic fluid temperature detected through the signal from the temperature sensor is lower than the predetermined hydraulic fluid upper limit temperature.

The apparatus for controlling a control valve according to the aspect of the present invention may further include a shuttle valve selecting a relatively higher pressure among pilot signal pressures input at both ends of the control valve; and a pressure sensor detecting the pilot signal pressure output from the shuttle valve and transmitting a detection signal to the controller.

The apparatus for controlling a control valve according to the aspect of the present invention may further include an electro proportional pressure reducing valve generating a secondary pressure that corresponds to an electrical signal applied from the controller and applying the secondary pressure to a regulator that controls a discharge flow rate of the hydraulic pump; and an electro proportional valve applying the pilot signal pressure that is proportional to the electrical signal output from the controller in proportion to the operation amount of the operation lever to the control valve.

The operation lever may be an electronic operation lever that outputs an electrical signal in proportion to the operation amount.

The operation lever may be a hydraulic operation lever that outputs pilot signal pressure to correspond to the operation amount.

In controlling the discharge flow rate of the hydraulic pump by the calculated gain value, a moving average of the pilot signal pressure that is applied to the control valve may be used as an effective input, and the discharge flow rate of the hydraulic pump may be delayed by differently setting an average parameter according to the calculated gain value.

In controlling the discharge flow rate of the hydraulic pump by the calculated gain value, a multi-order polynomial for the electrical signal that is applied to the electro proportional pressure reducing valve to correspond to the pilot signal pressure applied to the control valve may be determined as the following equation 1, and the discharge flow rate of the hydraulic pump may be delayed by changing coefficients according to the calculated gain value,

y=a*Pi²+b*Pi+c

where, y is an output value of the electrical signal applied to the electro proportional pressure reducing valve, and a, b, and c are a=(1/gain)*A, b=(1/gain)*B, and c=(1/gain)*C (here, A, B and C are constants).

In controlling the discharge flow rate of the hydraulic pump by the calculated gain value, an exponential function for the electrical signal that is applied to the electro proportional pressure reducing valve to correspond to the pilot signal pressure applied to the control valve may be determined as the following equation 2, and the discharge flow rate of the hydraulic pump may be delayed by changing coefficients according to the calculated gain value,

y=a*e^{(b*x)}+c

where, y is an output value of the electrical signal applied to the electro proportional pressure reducing valve, and a, b, and c are a=(1/gain)*A, b=(1/gain)*B, and c=(1/gain)*C (here, A, B and C are constants).

In controlling the discharge flow rate of the hydraulic pump by the calculated gain value, a moving average of the electric signal that corresponds to the operation amount of the electronic operation lever may be used as an effective input, and the discharge flow rate of the hydraulic pump may be delayed by differently setting an average parameter according to the calculated gain value.

In controlling the discharge flow rate of the hydraulic pump by the calculated gain value, a multi-order polynomial for the electrical signal that is applied to the electro proportional pressure reducing valve to correspond to the operation amount of the electronic operation lever may be determined as the following equation 1, and the discharge flow rate of the hydraulic pump may be delayed by changing coefficients according to the calculated gain value,

y=a*Pi²+b*Pi+c

where, y is an output value of the electrical signal applied to the electro proportional pressure reducing valve, and a, b, and c are a=(1/gain)*A, b=(1/gain)*B, and c=(1/gain)*C (here, A, B and C are constants).

In controlling the discharge flow rate of the hydraulic pump by the calculated gain value, an exponential function for the electrical signal that is applied to the electro proportional pressure reducing valve to correspond to the operation amount of the electronic operation lever may be determined as the following equation 2, and the discharge flow rate of the hydraulic pump may be delayed by changing coefficients according to the calculated gain value,

y=a*e^{(b*x)}+c

where, y is an output value of the electrical signal applied to the electro proportional pressure reducing valve, and a, b, and c are a=(1/gain)*A, b=(1/gain)*B, and c=(1/gain)*C (here, A, B and C are constants).

### Advantageous Effect

According to the present invention having the above-described configuration, the spool stick phenomenon can be eliminated through quick shifting of the spool of the directional valve in the case where the temperature of the hydraulic fluid becomes equal to or lower than the predetermined temperature in winter season with below zero temperatures, and thus human accident due to malfunction of the working device and safety accident due to collision with a peripheral object can be reduced. Further, since the discharge flow rate of the hydraulic pump is reduced as much as the pilot signal pressure delay that is caused by the increase of the viscosity of the hydraulic fluid, the pressure loss and load pressure can be reduced, and an abnormal phenomenon, such as trembling of the working device, can be prevented.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a hydraulic circuit diagram of an apparatus for controlling a control valve for a construction machine according to an embodiment of the present invention;

FIG. 2 is a control algorithm diagram of a method for controlling a control valve for a construction machine according to an embodiment of the present invention;

FIG. 3 is a graph illustrating a relationship between a stroke of an operation lever and a spool shifting pressure of a control valve in an apparatus for controlling a control value for a construction machine according to an embodiment of the present invention;

FIG. 4 is a hydraulic circuit diagram of a control device that is used in a method for controlling a discharge flow rate of a hydraulic pump for a construction machine according to an embodiment of the present invention;

FIG. 5 is another hydraulic circuit diagram of a control device that is used in a method for controlling a discharge flow rate of a hydraulic pump for a construction machine according to an embodiment of the present invention;

FIG. 6 is a control algorithm diagram of an apparatus for controlling a discharge flow rate of a hydraulic pump for a construction machine illustrated in FIG. 4; and

FIG. 7 is a control algorithm diagram of an apparatus for controlling a discharge flow rate of a hydraulic pump for a construction machine illustrated in FIG. 5.

### EXPLANATION OF REFERENCE NUMERALS FOR MAIN PARTS IN THE DRAWING

1: hydraulic pump

2: control valve

3: operation lever

4: hydraulic fluid tank

5: temperature sensor

6: controller

7: shuttle valve

8: pressure sensor

9: regulator

10: electro proportional pressure reducing valve

11: electro proportional valve

12: pilot pump

### DETAILED DESCRIPTION OF THE INVENTION

Hereinafter, an apparatus and method for controlling a control valve, and a method for controlling a discharge flow rate of a hydraulic pump for a construction machine in accordance with preferred embodiments of the present invention will be described in detail with reference to the accompanying drawings.

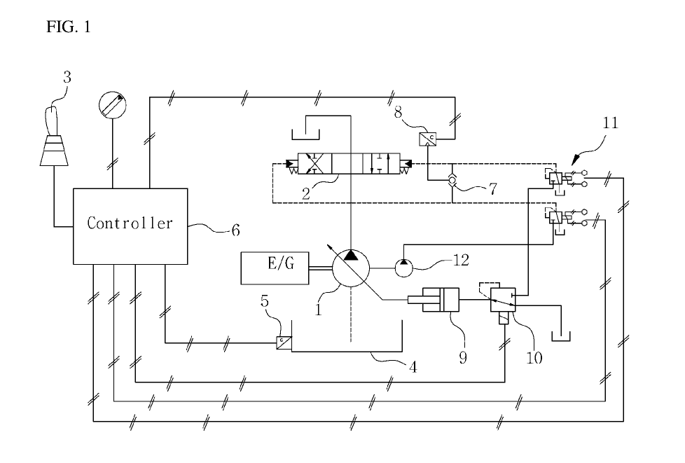

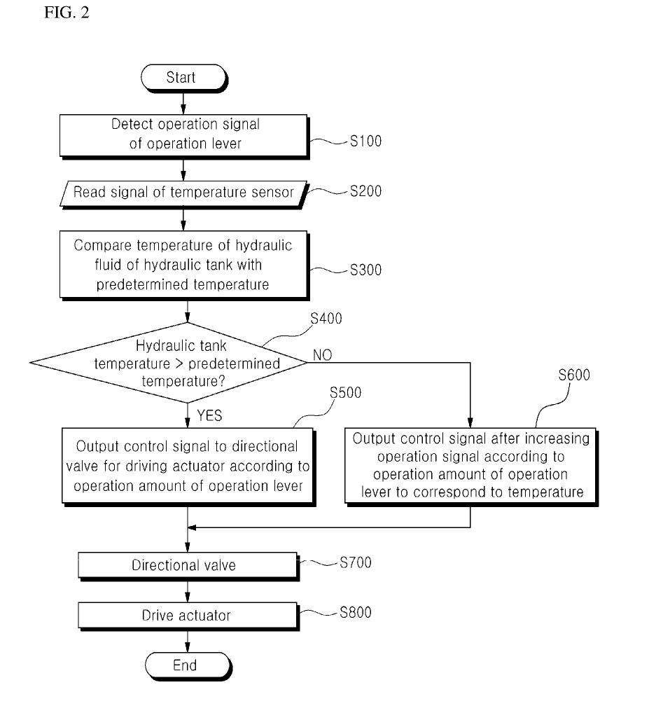

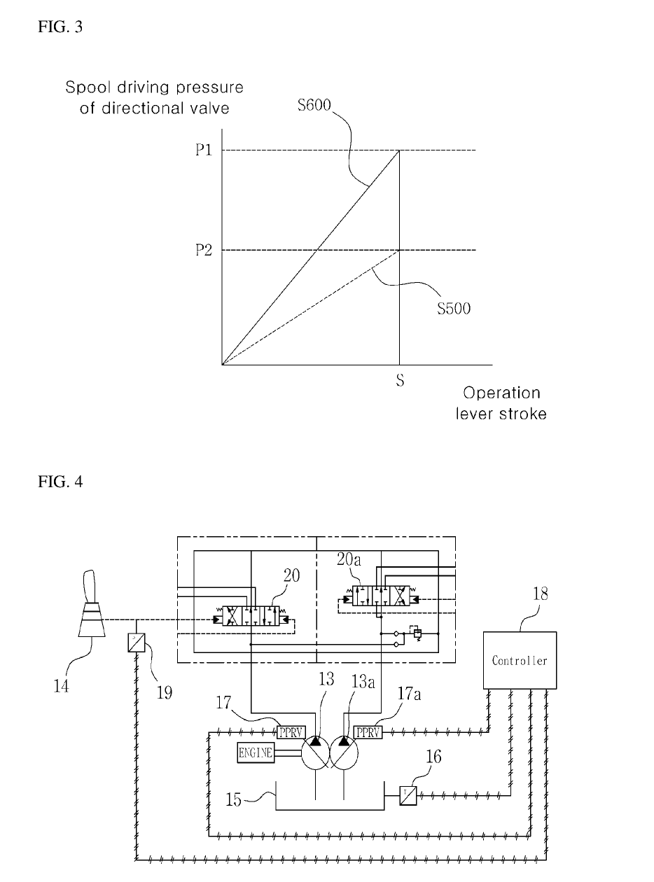

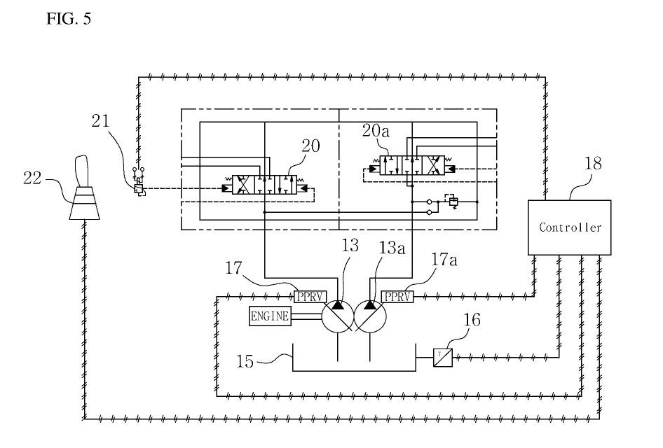

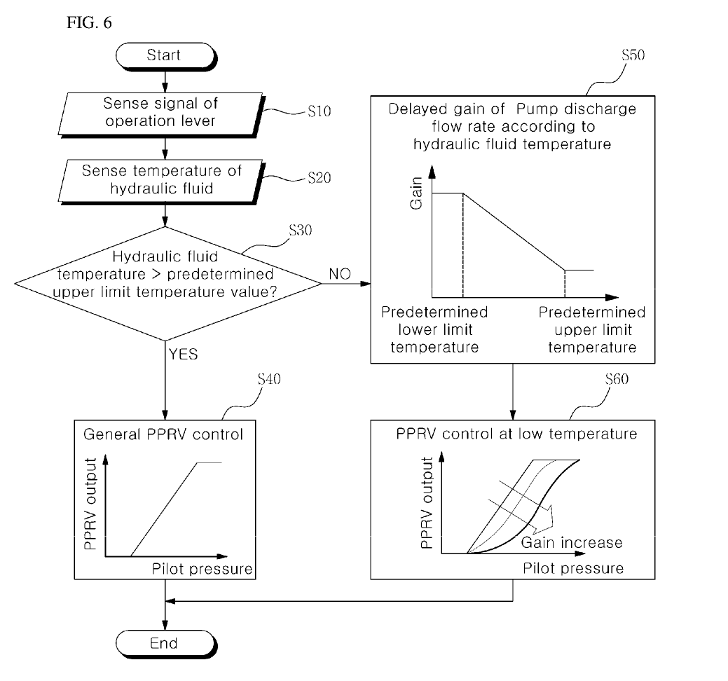

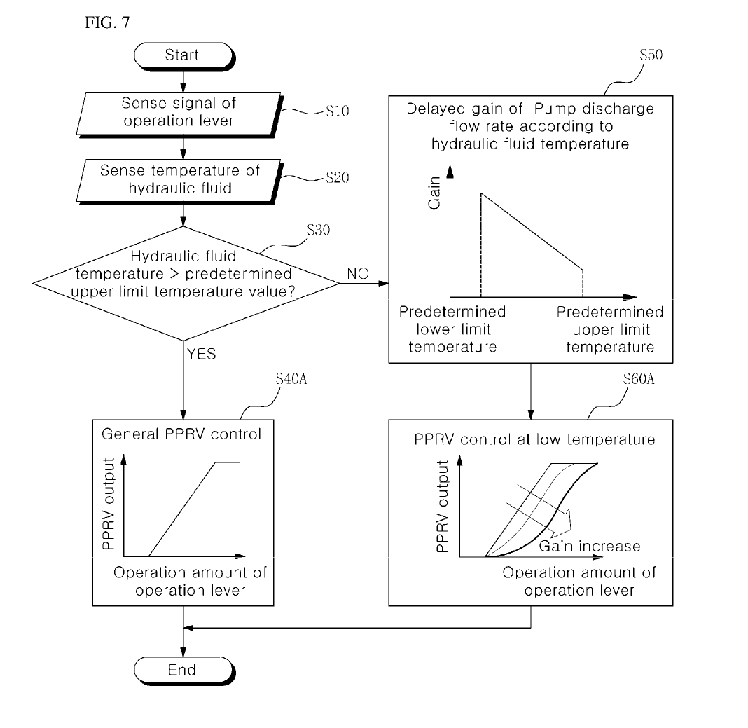

FIG. 1 is a hydraulic circuit diagram of an apparatus for controlling a control valve for a construction machine according to an embodiment of the present invention, FIG. 2 is a control algorithm diagram of a method for controlling a control valve for a construction machine according to an embodiment of the present invention, and FIG. 3 is a graph illustrating a relationship between a stroke of an operation lever and a spool shifting pressure of a control valve in an apparatus for controlling a control value for a construction machine according to an embodiment of the present invention. FIG. 4 is a hydraulic circuit diagram of a control device that is used in a method for controlling a discharge flow rate of a hydraulic pump for a construction machine according to an embodiment of the present invention, and FIG. 5 is another hydraulic circuit diagram of a control device that is used in a method for controlling a discharge flow rate of a hydraulic pump for a construction machine according to an embodiment of the present invention. FIG. 6 is a control algorithm diagram of an apparatus for controlling a discharge flow rate of a hydraulic pump for a construction machine illustrated in FIG. 4, and FIG. 7 is a control algorithm diagram of an apparatus for controlling a discharge flow rate of a hydraulic pump for a construction machine illustrated in FIG. 5.

Referring to FIG. 1, according to an embodiment of the present invention, there is provided an apparatus for controlling a control valve for a construction machine, which includes a variable displacement hydraulic pump 1 (hereinafter referred to as a “hydraulic pump”) connected to an engine; a hydraulic actuator (not illustrated) driven by hydraulic fluid that is supplied from the hydraulic pump 1; a control valve 2 installed in a flow path between the hydraulic pump 1 and the hydraulic actuator and shifted to control a start, stop, and direction change of the hydraulic actuator; an operation lever 3 outputting an operation signal corresponding to an operation amount; a temperature sensor 5 detecting a hydraulic fluid temperature of a hydraulic fluid tank 4 connected to the hydraulic pump 1; and a controller 6 applying a control signal that corresponds to the operation amount of the operation lever 3 to the control valve 2 if the hydraulic fluid temperature detected through a signal from the temperature sensor 5 is higher than a predetermined temperature, and adjusting the operation signal according to the operation amount of the operation lever 3 in a predetermined increment rate to correspond to the detected hydraulic fluid temperature and applying the adjusted control signal to the control valve 2 if the hydraulic fluid temperature detected through the signal from the temperature sensor 5 is lower than the predetermined temperature.

The apparatus for controlling a control valve according an embodiment of the present invention may further include a shuttle valve 7 selecting a relatively higher pressure among pilot signal pressures input at both ends of the control valve 2, and a pressure sensor 8 detecting the pilot signal pressure output from the shuttle valve 7 and transmitting a detection signal to the controller 6.

The apparatus for controlling a control valve according an embodiment of the present invention may further include an electro proportional pressure reducing valve 10 generating a secondary pressure that corresponds to an electrical signal applied from the controller 6 and applying the secondary pressure to a regulator that controls a discharge flow rate of the hydraulic pump 1, and an electro proportional valve 11 applying the pilot signal pressure that is proportional to the electrical signal output from the controller 6 in proportion to the operation amount of the operation lever 3 to the control valve 2.

The operation lever 3 may be an electronic operation lever that outputs an electrical signal in proportion to the operation amount.

The operation lever 3 may be a hydraulic operation lever that outputs pilot signal pressure to correspond to the operation amount.

Referring to FIGS. 2 and 3, according to another embodiment of the present invention, there is provided a method for controlling a control valve for a construction machine including a variable displacement hydraulic pump 1 (hereinafter referred to as a “hydraulic pump”), a hydraulic actuator driven by hydraulic fluid that is supplied from the hydraulic pump 1, a control valve 2 installed in a flow path between the hydraulic pump 1 and the hydraulic actuator and shifted to control a start, stop, and direction change of the hydraulic actuator, an operation lever 3 outputting and operation signal corresponding to an operation amount, and a temperature sensor 5 detecting a hydraulic fluid temperature of a hydraulic fluid tank 4 connected to the hydraulic pump 1, which includes detecting the operation signal that corresponding to the operation amount of the operation lever 3 (S100); comparing the hydraulic fluid temperature detected through a signal of the temperature sensor 5 with a predetermined temperature (S300); applying a control signal that corresponds to the operation amount of the operation lever 3 to the control valve 2 if the hydraulic fluid temperature detected through the signal from the temperature sensor 5 is higher than a predetermined temperature (S400 and S500); and adjusting the operation signal according to the operation amount of the operation lever 3 in a predetermined increment rate to correspond to the detected hydraulic fluid temperature and applying the adjusted control signal to the control valve 2 if the hydraulic fluid temperature detected through the signal from the temperature sensor 5 is lower than the predetermined temperature (S400 and S600).

At S100, if the operation lever 3 for operating a working device is operated, an electrical signal or pilot signal pressure, which is output according to the operation amount of the operation lever 3, is detected by the controller 6.

At S200, the temperature of the hydraulic fluid in the hydraulic fluid tank 4 is measured by the temperature sensor 5, and a detection signal is transmitted from the temperature sensor 5 to the controller 6.

At S300, the temperature of the hydraulic fluid of the hydraulic fluid tank 4, which is detected by the temperature sensor 5 is compared with a predetermined hydraulic fluid temperature.

At S400, if the detected hydraulic fluid temperature is higher than the predetermined hydraulic fluid temperature, the processing proceeds to S500, whereas if the detected hydraulic fluid temperature is lower than the predetermined hydraulic fluid temperature, the processing proceeds to S600.

At S500, if the hydraulic fluid temperature that is detected by the temperature sensor 5 is higher than the predetermined hydraulic fluid temperature, a control signal that corresponds to the operation amount of the operation lever 3 is applied from the controller 6 to the electro proportional valve 11. The hydraulic fluid that is discharged from the pilot pump 12 is supplied to the control valve 2 as the pilot signal pressure via the electro proportional valve 11 that makes the hydraulic fluid in proportion to the electrical signal that is applied to the electro proportional valve 11. That is, as shown as S500 in the graph of FIG. 3, if the operation lever 3 is operated as much as a stroke S, pilot signal pressure P1 that corresponds to the operation amount may be applied to the control valve 2.

Further, since the electrical signal is applied from the controller 6 to the electro proportional pressure reducing valve 10, secondary pressure is generated to correspond to the electrical signal, and the generated secondary pressure is applied to the regulator 9 that controls the discharge flow rate of the hydraulic pump 1. Since an inclination angle of a swash plate of the hydraulic pump 1 is controlled by the operation of the regulator 9, the discharge flow rate of the hydraulic pump 1 can be controlled through the operation of the regulator 9.

As described above, the spool of the control valve 2 is shifted by the pilot signal pressure that is applied from the pilot pump 12 through the electro proportional valve 11 in accordance with the operation of the operation lever 3 (S700), and the regulator 9 is operated by the pilot signal pressure that is applied from the pilot pump 12 through the electro proportional pressure reducing valve 10 to control the discharge flow rate of the hydraulic pump 1.

Accordingly, the hydraulic fluid that is discharged from the hydraulic pump 1 is supplied to the hydraulic actuator through the control valve 2 to operate the working device (S800), and the hydraulic fluid that is discharged from the hydraulic actuator returns to the hydraulic fluid tank 4 via the control valve 2.

At S600, if the hydraulic fluid temperature that is detected through the signal from the temperature sensor 5 is lower than the predetermined temperature, the operation signal that is applied to the electro proportional valve 11 in accordance with the operation amount of the operation lever 3 is controlled to be increased to correspond to the detected hydraulic fluid temperature. As shown as S600 in the graph of FIG. 3, even if the operation lever 3 is operated as much as the stroke S, the pilot signal pressure that corresponds to the operation amount may be formed to be high at a predetermined rate (P2) to be applied to the control valve 2. Accordingly, even in the case where the operation lever 3 is finely operated as much as the same stroke S, the pilot signal pressure that is applied to the control valve 2 becomes high, and thus can rapidly pass through the notch section that is formed in the spool of the control valve 2.

Through this, in the case where the hydraulic fluid temperature is lower than the predetermined temperature in the winter season, the operation signal according to the operation amount of the operation lever 3 is controlled to be high to correspond to the detected hydraulic fluid temperature, and is applied to the control valve 2 to rapidly shift the spool. Accordingly, the spool stick phenomenon that occurs due to the thermal expansion in the notch section of the spool can be prevented, and thus malfunction of the working device can be prevented.

Referring to FIGS. 4 to 6, according to still another embodiment of the present invention, there is provided a method for controlling a discharge flow rate of a hydraulic pump for a construction machine including a variable displacement hydraulic pump (hereinafter referred to as a “hydraulic pump”) 13 or 13a connected to an engine, a hydraulic actuator (not illustrated) driven by hydraulic fluid that is supplied from the hydraulic pump 13 or 13a, a hydraulic operation lever 14 outputting an operation signal to correspond to an operation amount, a control valve 20 or 20a installed in a flow path between the hydraulic pump 13 or 13a and the hydraulic actuator and shifted to control a start, stop, and direction change of the hydraulic actuator, a temperature sensor 16 detecting a hydraulic fluid temperature of a hydraulic fluid tank 15, an electro proportional pressure reducing valve (PPRV) 17 or 17a controlling a discharge flow rate of the hydraulic pump 13 or 13a through a secondary pressure that is generated to correspond to an applied electrical signal, and a controller 18 receiving a detection signal of the hydraulic fluid temperature that is sensed by the temperature sensor 16 and applying an electrical signal to the electro proportional pressure reducing valve 17 or 17a, which includes detecting a pilot signal pressure that is applied to the control valve 20 or 20a to correspond to the operation amount of the operation lever 14 (S10); comparing the hydraulic fluid temperature detected by the temperature sensor 16 with a predetermined hydraulic fluid upper limit temperature (S30); applying an electrical signal that corresponds to the pilot signal pressure that is applied to the control valve 20 or 20a to the electro proportional pressure reducing valve 17 or 17a if the hydraulic fluid temperature detected through the signal from the temperature sensor 16 is higher than the predetermined hydraulic fluid upper limit temperature (S40); and calculating a gain value for decreasing the discharge flow rate of the hydraulic pump 13 or 13a so that the gain value becomes larger as the detected hydraulic fluid temperature that belongs between certain hydraulic fluid upper limit temperature and lower limit temperature approaches the lower limit temperature and applying the electrical signal to the electro proportional pressure reducing valve 17 or 17a to correspond to the calculated gain value if the hydraulic fluid temperature detected through the signal from the temperature sensor 16 is lower than the predetermined hydraulic fluid upper limit temperature (S50 and S60).

At S10, the pilot signal pressure that is applied to the control valve 20 or 20a to correspond to the operation amount of the hydraulic operation lever 14 is measured by the pressure sensor 19, and a detection signal is transmitted to the controller 18.

At S20, the temperature of the hydraulic fluid of the hydraulic fluid tank 15 is measured by the temperature sensor 16 and a detection signal is transmitted to the controller 18.

At S30, the hydraulic fluid temperature that is detected by the temperature sensor 16 is compared with a predetermined hydraulic fluid temperature. If the detected hydraulic fluid temperature is higher than the predetermined hydraulic fluid temperature, the processing proceeds to S40, whereas if the detected hydraulic fluid temperature is lower than the predetermined hydraulic fluid temperature, the processing proceeds to S50.

At S40, if the hydraulic fluid temperature that is detected by the temperature sensor 16 is higher than the predetermined hydraulic fluid temperature, a control signal that corresponds to the pilot signal pressure that is applied to the control valve 20 or 20a is applied to the electro proportional pressure reducing valve 17 or 17a. Accordingly, the electro proportional pressure reducing valve 17 or 17a generates secondary pressure that corresponds to the electrical signal that is applied to the electro proportional pressure reducing valve 17 or 17a, and applies the generated secondary pressure to a regulator (not illustrated) that controls an inclination angle of a swash plate of the hydraulic pump 13 or 13a to control the discharge flow rate of the hydraulic pump 13 or 13a.

At S50 and S60, if the hydraulic fluid temperature that is detected by the temperature sensor 16 is lower than the predetermined hydraulic fluid temperature, the gain value for decreasing the discharge flow rate of the hydraulic pump 13 or 13a is calculated so that the gain value becomes larger as the detected hydraulic fluid temperature that belongs between the certain hydraulic fluid upper limit temperature and the lower limit temperature approaches the lower limit temperature, and the electrical signal is applied to the electro proportional pressure reducing valve 17 or 17a to correspond to the calculated gain value.

In controlling the discharge flow rate of the hydraulic pump 13 or 13a by the calculated gain value, a moving average of the pilot signal pressure that is applied to the control valve 20 is used as an effective input, and the discharge flow rate of the hydraulic pump 13 or 13a is delayed by differently setting an average parameter according to the calculated gain value.

In controlling the discharge flow rate of the hydraulic pump 13 or 13a by the calculated gain value, a multi-order polynomial for the electrical signal that is applied to the electro proportional pressure reducing valve 17 or 17a to correspond to the pilot signal pressure applied to the control valve 20 is determined as the following equation 1, and the discharge flow rate of the hydraulic pump 13 or 13a is delayed by changing coefficients according to the calculated gain value,

y=a*Pi²+b*Pi+c

where, y is an output value of the electrical signal applied to the electro proportional pressure reducing valve 17 or 17a, and a, b, and c are a=(1/gain)*A, b=(1/gain)*B, and c=(1/gain)*C (here, A, B and C are constants).

In controlling the discharge flow rate of the hydraulic pump 13 or 13a by the calculated gain value, an exponential function for the electrical signal that is applied to the electro proportional pressure reducing valve 17 or 17a to correspond to the pilot signal pressure applied to the control valve 20 is determined as the following equation 2, and the discharge flow rate of the hydraulic pump 13 or 13a is delayed by changing coefficients according to the calculated gain value,

y=a*e^{(b*x)}+c

where, y is an output value of the electrical signal applied to the electro proportional pressure reducing valve 17 or 17a, and a, b, and c are a=(1/gain)*A, b=(1/gain)*B, and c=(1/gain)*C (here, A, B and C are constants).

Referring to FIGS. 5 and 7, according to yet still another embodiment of the present invention, there is provided a method for controlling a discharge flow rate of a hydraulic pump for a construction machine including a variable displacement hydraulic pump (hereinafter referred to as a “hydraulic pump”) 13 or 13a, a hydraulic actuator (not illustrated) driven by hydraulic fluid that is supplied from the hydraulic pump 13 or 13a, an electronic operation lever 22 outputting an electrical signal to correspond to an operation amount, a control valve 20 or 20a installed in a flow path between the hydraulic pump 13 or 13a and the hydraulic actuator and shifted to control a start, stop, and direction change of the hydraulic actuator, a temperature sensor 16 detecting a hydraulic fluid temperature of a hydraulic fluid tank 15, and an electro proportional pressure reducing valve 17 or 17a controlling a discharge flow rate of the hydraulic pump 13 or 13a through a secondary pressure that is generated to correspond to an applied electrical signal, which includes detecting the electrical signal that is output in proportion to the operation amount of the operation lever 22 (S10); comparing the hydraulic fluid temperature detected by the temperature sensor 16 with a predetermined hydraulic fluid upper limit temperature (S30); applying an electrical signal that is proportional to the operation amount of the operation lever 22 to the electro proportional pressure reducing valve 17 or 17a if the hydraulic fluid temperature detected through the signal from the temperature sensor 16 is higher than the predetermined hydraulic fluid upper limit temperature (S40A); and calculating a gain value for decreasing the discharge flow rate of the hydraulic pump 13 or 13a so that the gain value becomes larger as the detected hydraulic fluid temperature that belongs between certain hydraulic fluid upper limit temperature and lower limit temperature approaches the lower limit temperature and applying the electrical signal to the electro proportional pressure reducing valve 17 or 17a to correspond to the calculated gain value if the hydraulic fluid temperature detected through the signal from the temperature sensor 16 is lower than the predetermined hydraulic fluid upper limit temperature (S50 and S60A).

In this case, except for the applying the electrical signal that is proportional to the operation amount of the operation lever 22 to the electro proportional pressure reducing valve 17 or 17a if the hydraulic fluid temperature detected through the signal from the temperature sensor 16 is higher than the predetermined hydraulic fluid upper limit temperature (S40A), and the calculating the gain value for decreasing the discharge flow rate of the hydraulic pump 13 or 13a so that the gain value becomes larger as the detected hydraulic fluid temperature that belongs between the certain hydraulic fluid upper limit temperature and the lower limit temperature approaches the lower limit temperature and applying the electrical signal to the electro proportional pressure reducing valve 17 or 17a to correspond to the calculated gain value if the hydraulic fluid temperature detected through the signal from the temperature sensor 16 is lower than the predetermined hydraulic fluid upper limit temperature (S50 and S60A), the method for controlling a discharge flow rate of a hydraulic pump according to this embodiment is the same as the method for controlling a discharge flow rate of a hydraulic pump as illustrated in FIGS. 4 and 6, and thus the detailed explanation thereof will be omitted.

Although the present invention has been described with reference to the preferred embodiments in the attached figures, it is to be understood that various equivalent modifications and variations of the embodiment can be made by a person having an ordinary skill in the art without departing from the spirit and scope of the present invention.

### INDUSTRIAL APPLICABILITY

According to the present invention having the above-described configuration, the spool stick phenomenon can be eliminated through heightening of the spool shifting speed of the directional valve in the case where the temperature of the hydraulic fluid becomes equal to or lower than the predetermined temperature in winter season with below zero temperatures, and thus the malfunction of the working device can be reduced. Further, since the discharge flow rate of the hydraulic pump is reduced as much as the pilot signal pressure delay that is caused by the increase of the viscosity of the hydraulic fluid, the pressure loss and the load pressure can be reduced.

What is claimed is:

1. An apparatus for controlling a control valve for a construction machine comprising:
a variable displacement hydraulic pump;
a hydraulic actuator driven by hydraulic fluid that is supplied from the hydraulic pump;
a control valve installed in a flow path between the hydraulic pump and the hydraulic actuator and shifted to control a start, stop, and direction change of the hydraulic actuator;
an operation lever outputting an operation signal corresponding to an operation amount;
a temperature sensor detecting a hydraulic fluid temperature of a hydraulic fluid tank connected to the hydraulic pump; and
a controller applying a control signal that corresponds to the operation amount of the operation lever to the control valve if the hydraulic fluid temperature detected through a signal from the temperature sensor is higher than a predetermined temperature, and adjusting the operation signal according to the operation amount of the operation lever in a predetermined increment rate to correspond to the detected hydraulic fluid temperature and applying the adjusted control signal to the control valve if the hydraulic fluid temperature detected through the signal from the temperature sensor is lower than the predetermined temperature.

2. The apparatus for controlling a control valve according to claim 1, further comprising:
a shuttle valve selecting a relatively higher pressure among pilot signal pressures input at both ends of the control valve; and
a pressure sensor detecting the pilot signal pressure output from the shuttle valve and transmitting a detection signal to the controller.

3. The apparatus for controlling a control valve according to claim 1, further comprising:
an electro proportional pressure reducing valve generating a secondary pressure that corresponds to an electrical signal applied from the controller and applying the secondary pressure to a regulator that controls a discharge flow rate of the hydraulic pump; and
an electro proportional valve applying the pilot signal pressure that is proportional to the electrical signal output from the controller in proportion to the operation amount of the operation lever to the control valve.

4. The apparatus for controlling a control valve according to claim 1, wherein the operation lever is an electronic operation lever that outputs an electrical signal in proportion to the operation amount.

5. The apparatus for controlling a control valve according to claim 1, wherein the operation lever is a hydraulic operation lever that outputs pilot signal pressure to correspond to the operation amount.

6. A method for controlling a control valve for a construction machine including a variable displacement hydraulic pump, a hydraulic actuator driven by hydraulic fluid that is supplied from the hydraulic pump, a control valve installed in a flow path between the hydraulic pump and the hydraulic actuator and shifted to control a start, stop, and direction change of the hydraulic actuator, an operation lever outputting and operation signal corresponding to an operation amount, and a temperature sensor detecting a hydraulic fluid temperature of a hydraulic fluid tank connected to the hydraulic pump, the method comprising:
detecting the operation signal that corresponding to the operation amount of the operation lever;
comparing the hydraulic fluid temperature detected through a signal of the temperature sensor with a predetermined temperature;
applying a control signal that corresponds to the operation amount of the operation lever to the control valve if the hydraulic fluid temperature detected through the signal from the temperature sensor is higher than a predetermined temperature; and
adjusting the operation signal according to the operation amount of the operation lever in a predetermined increment rate to correspond to the detected hydraulic fluid temperature and applying the adjusted control signal to the control valve if the hydraulic fluid temperature detected through the signal from the temperature sensor is lower than the predetermined temperature.

7. A method for controlling a discharge flow rate of a hydraulic pump for a construction machine including a variable displacement hydraulic pump, a hydraulic actuator driven by hydraulic fluid that is supplied from the hydraulic pump, a hydraulic operation lever outputting an operation signal to correspond to an operation amount, a control valve installed in a flow path between the hydraulic pump and the hydraulic actuator and shifted to control a start, stop, and direction change of the hydraulic actuator, a temperature sensor detecting a hydraulic fluid temperature of a hydraulic fluid tank, and an electro proportional pressure reducing valve controlling a discharge flow rate of the hydraulic pump through a secondary pressure that is generated to correspond to an applied electrical signal, the method comprising:
detecting a pilot signal pressure that is applied to the control valve to correspond to the operation amount of the operation lever;
comparing the hydraulic fluid temperature detected by the temperature sensor with a predetermined hydraulic fluid upper limit temperature;
applying an electrical signal that corresponds to the pilot signal pressure that is applied to the control valve to the electro proportional pressure reducing valve if the hydraulic fluid temperature detected through the signal from the temperature sensor is higher than the predetermined hydraulic fluid upper limit temperature; and
calculating a gain value for decreasing the discharge flow rate of the hydraulic pump so that the gain value becomes larger as the detected hydraulic fluid temperature that belongs between certain hydraulic fluid upper limit temperature and lower limit temperature approaches the lower limit temperature and applying the electrical signal to the electro proportional pressure reducing valve to correspond to the calculated gain value if the hydraulic fluid temperature detected through the signal from the temperature sensor is lower than the predetermined hydraulic fluid upper limit temperature.

8. A method for controlling a discharge flow rate of a hydraulic pump for a construction machine including a variable displacement hydraulic pump, a hydraulic actuator driven by hydraulic fluid that is supplied from the hydraulic pump, an electronic operation lever outputting an electrical signal to correspond to an operation amount, a control valve installed in a flow path between the hydraulic pump and the hydraulic actuator and shifted to control a start, stop, and direction change of the hydraulic actuator, a temperature sensor detecting a hydraulic fluid temperature of a hydraulic fluid tank, and an electro proportional pressure reducing valve controlling a discharge flow rate of the hydraulic pump through a secondary pressure that is generated to correspond to an applied electrical signal, the method comprising:
detecting the electrical signal that is output in proportion to the operation amount of the operation lever;
comparing the hydraulic fluid temperature detected by the temperature sensor with a predetermined hydraulic fluid upper limit temperature;
applying an electrical signal that is proportional to the operation amount of the operation lever to the electro proportional pressure reducing valve if the hydraulic fluid temperature detected through the signal from the temperature sensor is higher than the predetermined hydraulic fluid upper limit temperature; and
calculating a gain value for decreasing the discharge flow rate of the hydraulic pump so that the gain value becomes larger as the detected hydraulic fluid temperature that belongs between certain hydraulic fluid upper limit temperature and lower limit temperature approaches the lower limit temperature and applying the electrical signal to the electro proportional pressure reducing valve to correspond to the calculated gain value if the hydraulic fluid temperature detected through the signal from the temperature sensor is lower than the predetermined hydraulic fluid upper limit temperature.

9. The method for controlling a discharge flow rate of a hydraulic pump according to claim 7, wherein in controlling the discharge flow rate of the hydraulic pump by the calculated gain value, a moving average of the pilot signal pressure that is applied to the control valve is used as an effective input, and the discharge flow rate of the hydraulic pump is delayed by differently setting an average parameter according to the calculated gain value.

10. The method for controlling a discharge flow rate of a hydraulic pump according to claim 7, wherein in controlling the discharge flow rate of the hydraulic pump by the calculated gain value, a multi-order polynomial for the electrical signal that is applied to the electro proportional pressure reducing valve to correspond to the pilot signal pressure applied to the control valve is determined as the following equation 1, and the discharge flow rate of the hydraulic pump is delayed by changing coefficients according to the calculated gain value,
y=a*Pi²+b*Pi+c
where, y is an output value of the electrical signal applied to the electro proportional
pressure reducing valve, and a, b, and c are a=(1/gain)*A, b=(1/gain)*B, and c =(1/gain)*C (here, A, B and C are constants).

11. The method for controlling a discharge flow rate of a hydraulic pump according to claim 7, wherein in controlling the discharge flow rate of the hydraulic pump by the calculated gain value, an exponential function for the electrical signal that is applied to the electro proportional pressure reducing valve to correspond to the pilot signal pressure applied to the control valve is determined as the following equation 2, and the discharge flow rate of the hydraulic pump is delayed by changing coefficients according to the calculated gain value,
y=a*e^{(b*x)}+c
where, y is an output value of the electrical signal applied to the electro proportional pressure reducing valve, and a, b, and c are a=(1/gain)*A, b=(1/gain)*B, and c=(1/gain)*C (here, A, B and C are constants).

12. The method for controlling a discharge flow rate of a hydraulic pump according to claim 8, wherein in controlling the discharge flow rate of the hydraulic pump by the calculated gain value, a moving average of the pilot signal pressure that is applied to the control valve is used as an effective input, and the discharge flow rate of the hydraulic pump is delayed by differently setting an average parameter according to the calculated gain value.

13. The method for controlling a discharge flow rate of a hydraulic pump according to claim 8, wherein in controlling the discharge flow rate of the hydraulic pump by the calculated gain value, a multi-order polynomial for the electrical signal that is applied to the electro proportional pressure reducing valve to correspond to the pilot signal pressure applied to the control valve is determined as the following equation 1, and the discharge flow rate of the hydraulic pump is delayed by changing coefficients according to the calculated gain value,
y=a*Pi²+b*Pi+c
where, y is an output value of the electrical signal applied to the electro proportional pressure reducing valve, and a, b, and c are a=(1/gain)*A, b=(1/gain)*B, and c=(1/gain)*C (here, A, B and C are constants).

14. The method for controlling a discharge flow rate of a hydraulic pump according to claim 8, wherein in controlling the discharge flow rate of the hydraulic pump by the calculated gain value, an exponential function for the electrical signal that is applied to the electro proportional pressure reducing valve to correspond to the pilot signal pressure applied to the control valve is determined as the following equation 2, and the discharge flow rate of the hydraulic pump is delayed by changing coefficients according to the calculated gain value,
y=a*e^{(b*x)}+c
where, y is an output value of the electrical signal applied to the electro proportional
pressure reducing valve, and a, b, and c are a=(1/gain)*A, b=(1/gain)*B, and c=(1/gain)*C (here, A, B and C are constants).
